(19) United States
(12) Patent Application Publication
(10) Pub. No.: US 2025/0184547 A1
(43) Pub. Date: Jun. 5, 2025

(54) METHOD FOR RECORDING BROADCAST CONTENT

(71) Applicant: TiVo Platform Technologies LLC, San Jose, CA (US)

(72) Inventors: Benjamin HARDEN, Draper, UT (US); Michael BREHM, Allen, TX (US)

(21) Appl. No.: 18/527,311

(22) Filed: Dec. 3, 2023

(51) Int. Cl. H04N 21/231; H04N 21/232; H04N 21/239; H04N 21/2747

(52) U.S. Cl. CPC H04N 21/23116; H04N 21/232; H04N 21/2393; H04N 21/2747

(57) ABSTRACT

A method comprises: receiving from media devices requests to record program content broadcast in a given time window on a given channel; determining a number of requests for recording the program content based at least on a total number of the requests and a likelihood that playback of a recordal will be requested by a media device; requesting a storage system to make the requests for recording; receiving from the storage system identifiers corresponding to the determined number, each identifier identifying a location in the storage system of a respective recording of the program content; responsive to receiving a request from a media device for playback of the program content, allocating an identifier from the identifiers to the media device and removing the identifier from the identifiers available for subsequent playback requests; and providing the identifier to the media device so that the media device can retrieve the recording.

### FIELD

The present invention relates to a method for recording broadcast content.

### BACKGROUND

Referring now to FIG. 1, U.S. Pat. No. 10,448,112 from Tivo Solutions Inc., the disclosure of which is herein incorporated by reference, discloses a content management system, CMS, 100 that enables users to manage media content collections.

The system 100 includes one or more media devices 116, including media devices 116-1 and media devices 116-2. As used herein, a media device 116 generally refers to any type of computing device that is capable of receiving media content items, such as television programs, movies, streaming content, video on demand (VOD) content, etc., from a cable signal, terrestrial signal, digital network-based data, etc. In FIG. 1, for example, a media device 116-1 may include a TV-tuner input that can be used to play, record, stream, and/or otherwise access media content items received from one or more content sources 102. Content sources 102 generally may include broadcast content sources and/or broadband content sources. For example, one content source 102 may include a live television broadcast feed that is provided by a cable operator. Other example content sources 102 include, but are not limited to, Video On Demand (VOD) libraries, third party content providers (e.g., Netflix®, Amazon Prime®, etc.), web-based media content, satellite broadcast content, terrestrial broadcast content, etc. Example media devices 116-1 include, but are not limited to, a set-top box (STB), digital video recorders (DVRs), personal computers, tablet computers, handheld devices, televisions, and other computing devices.

System 100 further includes one or more IP-enabled media devices 116-2. In general, an IP-enabled media device 116-2 may refer to any type of computing device that is capable of receiving media content over one or more networks 114, such as the public Internet, intranet, LAN, WAN, etc., but which may or may not include a TV-tuner input. Examples of media devices 116-2 include, without limitation, STBs, DVRs, personal computers, smartphones, tablets, laptops, game devices, media servers, digital media receivers, televisions, terrestrial antennas, etc. A typical user may own several media devices 116, which may be located and used at various locations throughout the user's home and elsewhere.

Media devices 116 are coupled to cloud storage systems 112 and content sources 102 as well as operator headends 104, service provider systems 110, and/or via one or more networks 114. Networks 114 broadly represent one or more cable networks, LANs, WANs, cellular networks (e.g., LTE, HSPA, 3G, older technologies, etc.), and/or internetworks using any of wired, wireless, terrestrial microwave, or satellite links, and may include the public Internet. Furthermore, each media device 116 may be coupled to one or more other media devices via one or more networks 114.

Each media device 116 is generally configured to perform one or more actions related to media content items, including receiving media content items from content sources 102, playing media content items and scheduling recordings of media content items as well as possibly uploading all or portions of media content items to a cloud storage system, streaming media content items to other media devices, etc. The service provider system 110 generally may provide content listing information, content availability information, and other information about media content items. Examples of such systems are provided by Tivo Solutions Inc and MediaKind. A service provider system 110 may also manage cloud-based storage of media content items and provide media devices controlled access to media content items via one or more networks 114.

An operator headend 104 generally represents a system for receiving and processing broadcast television signals and other media content signals from one or more content sources 102, and for distributing media content based on the media content signals to media devices 116. As one example, an operator headend 104 may represent a cable television headend that receives and processes signals (e.g., received via satellite, coaxial cable, microwave link, fiber-optics, the Internet, etc.) from broadcast content sources 102, and distributes the processed video content to media devices 116 using a transmission infrastructure 106. Transmission infrastructure 106 generally may include components capable of transmitting media content items using any number of encoding and transmission formats including, but not limited to, quadrature amplitude modulation (QAM), Advanced Television Systems Committee (ATSC), satellite, Digital Video Broadcasting-Terrestrial (DVB-T), IP-based transmission over one or more networks, etc.

The operator headend 104 may host one or more media content management devices 108. In general, media content management devices 108 may include one or more computing devices and storage components configured to store media content items and to provide access to the media content items by media devices 116.

User accounts associated with the media content management system may be provided with an amount of storage at media content management devices 108 to store media content items selected for recording. The user accounts, for example, may be created and managed by a service provider system 110, and each user account may be associated with one or more media devices 116 (e.g., based on a user account login at the media devices). Media content items stored at media content management devices 108 may be delivered to media devices 116 by the operator headend 104 using the transmission infrastructure 106.

System 100 further includes one or more cloud storage systems 112. In general, a cloud storage system 112 represents a data storage system that is accessible to media devices 116 via one or more networks (e.g., a network 114) and is typically owned and managed by an entity other than a user of the media device 116. Cloud storage system 112 may be managed and operated by an operator of a service provider system 110, or a cloud storage system 112 may be operated by a third-party entity. Examples of third-party cloud storage systems include Amazon Web Services (AWS), Microsoft Azure, Google Cloud Storage, etc. Similar to storage available at an operator headend 104, user accounts associated with a service provider system 110 are provided with an amount of storage space at cloud storage system 112. The amount of storage available to each user account at media content management devices 108 and/or cloud storage system 112 may be presented to users as a single pool of available data storage or, in other examples, a user may be able to separately manage storage available at media content management devices 108 and at a cloud storage system 112.

Cloud storage system 112 generally may be used to store media content items selected for recording by users of media devices 116 (e.g., as individual scheduled recordings or as part of a media schedule associated with a media content collection). As such, the combination of service provider system 110 and cloud storage system 112 are commonly known as a network digital video recorder (nDVR). Media content items stored in cloud storage system 112 may be made available to users of media devices 116 until the media content items are selected for deletion by a user, exceed a cloud storage deletion policy, or based on any other deletion policy. Media content received by the operator headend 104 from content sources 102 may be delivered to the cloud storage system 112 via a fixed-bandwidth line to facilitate storage of media content items selected for recording by users.

The service provider system 110 comprises one or more computing devices generally configured to manage requests from media devices 116 (e.g., media content information and search requests, recording requests, playback requests, content deletion requests, pause point management across devices, etc.), and to manage storage of media content items across one or more operator headends 104 and cloud storage systems 112, among other services and features described herein.

In some jurisdictions, analogous to the legacy model, where the storage is physically located in the home, there is a requirement for storing individual private copies of broadcast content selected for recordal by respective users of various media devices in order to comply with copyright “fair use” provisions, rather than storing a single or limited number of copies of the content and directing multiple users to any given stored copy of the content for subsequent download to the media devices 116 and local display.

Clearly, this requirement involves large compute and I/O resource consumption within the CMS 100 to capture the potentially large number of private-copy replicas of content and this in turn severely limits the scalability of such systems.

In particular, the disk I/O required to write each user's individual copy of new recordings in parallel with the disk reads for play-out of existing recordings is generally the limiting factor, with overall disk storage and network capacity adding secondary constraints. These limitations translate to subscriber growth limitations in the end-to-end IPTV environment, add significant electricity and cooling costs, and add a considerable footprint of servers, disk arrays, and networking equipment.

These scalability limitations have typically been addressed with a combination of the following mitigation approaches:
As many content channels as possible provided by content sources 102 are configured to use a shared-copy implementation as opposed to a private-copy model. In shared copy, a single network recording is captured and used by all subscribers during play-out, instead of requiring that each subscriber is served their own individual replica of the recording. While offering immense scalability relief, this approach is often explicitly prohibited by certain content providers in their agreements with the service provider 10 system 110 operator. While each such operator's content agreements are different, many channels can still be required to be configured using a private-copy model where each user has a unique copy of recorded content.
Multiple separate instances of cloud storage system 112 can be deployed to spread the load of capturing these private-copy replicas. Different strategies to assign channels and/or subscribers can be used, but the additional instances add more disks for writing and decrease the disk I/O required for each individual instance. The trade-off is of course the additional I/O costs, electronic hardware waste, and additional power consumption for deploying and maintaining additional systems 112.
Service provider system 110 operators generally apply storage quotas for each subscriber to limit the overall storage required for each subscriber, as well as indirectly impact behavior on adding new recordings. When the quota is nearly full, a subscriber may become more hesitant to set up new recordings as they would lose older recordings. However, this has little impact on series recordings or recurring news programs. Those recordings are commonly configured to only keep a certain number of episodes, so they end up just becoming a pipeline where new episodes/programs are added while older ones expire and drop off without any subscriber interaction or consumption, resulting in the described waste.
Service provider system 110 operators can also pass along the expense of additional cloud storage system 112 equipment to the subscribers. However, this can lead to loss of service revenue as subscribers drop the feature and increase in subscriber churn, where subscribers are triggered by the price increase to leave the service altogether.

It is an object of the present invention to mitigate the above problems.

### SUMMARY

According to a first aspect of the present invention, there is provided a method for recording broadcast content according to claim 1.

Embodiments improve the efficiency of storage systems by optimizing the number of replicas of broadcast content to be generated within the storage system and to allow the storage system to operate with a lower capacity while still maintaining subscriber access to requested recordings.

This aspect involves shedding or dropping requests for private-copy replicas corresponding to recordings that are likely not going to be viewed by the subscribers. For example, if 1000 subscribers have a series recording configured that routinely has only 35% of the recordings ever being viewed, a service provider can choose to drop the capture of 300 of the 1000 requested replicas.

In particular, this aspect avoids a storage system capacity to simultaneously record a number of private copies of broadcast content being exceeded.

Embodiments capture record requests such that it is statistically improbable to fail to have a private recording available for a subscriber when responding to a playout requests, while still adhering to the requirement that each subscriber playing out content has their own individual copy of the recording.

According to a second aspect, there is provided a method for recording broadcast content according to claim 16.

This aspect can involve trimming the start and/or end time or padding of requests to record a particular program in order to limit the number of simultaneous recordings of private copy replicas of programming.

According to a third aspect, there is provided a method for recording broadcast content according to claim 19.

This aspect involves combining requests from a given media device to record successively broadcast programs on a given channel in order to limit the number of simultaneous recordings of private copy replicas of programming.

Embodiments can yield savings to disk I/O, power consumption, cooling and electronic waste.

Further aspects include a computer program product and a service provider system configured to perform the methods of the invention.

### BRIEF DESCRIPTION OF THE DRAWINGS

Embodiments of the invention will now be described, by way of example, with reference to the accompanying drawings, in which:

FIG. 1 illustrates a content management system on which a method for recording broadcast content according to an embodiment of the present invention is implemented; and

FIG. 2 illustrates an exemplary instance of a method for recording broadcast content according to an embodiment of the invention.

### DESCRIPTION OF THE EMBODIMENT

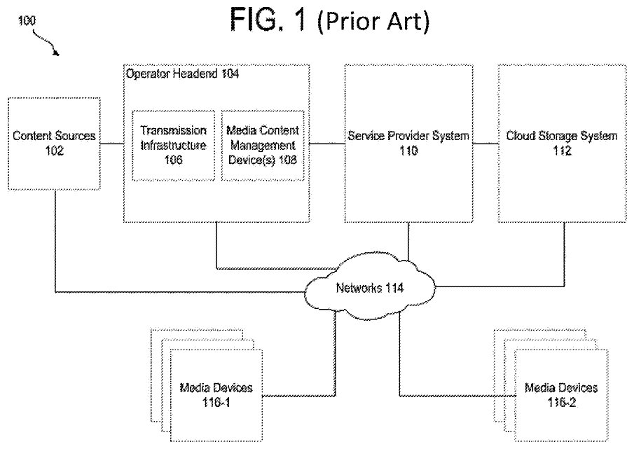

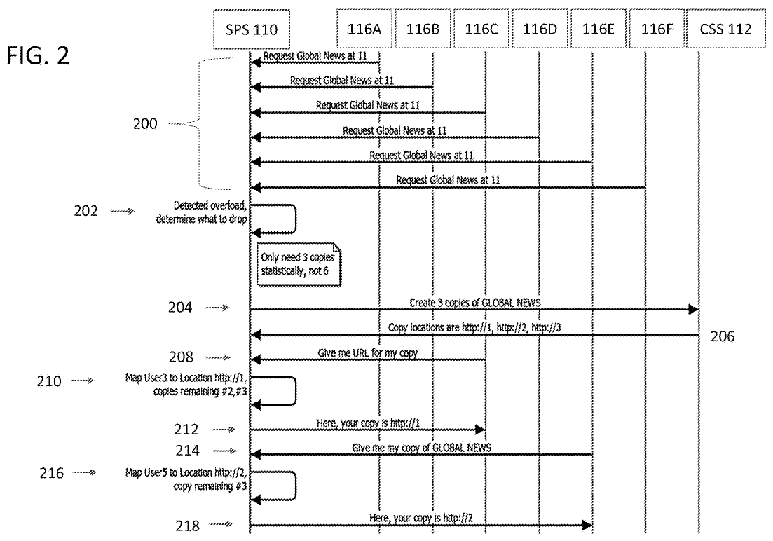

Referring now to FIG. 2, there is illustrated an exemplary instance of a method operated by a service provider system, SPS, such as the system 110 illustrated in FIG. 1 in accordance with an embodiment of the present invention.

While operating an application running on their respective media devices 116A . . . 116F, a number of users, in this case 6, select a program for recordal at a given time/day window on a given channel and communicate these requests to the SPS 110, step 200. In this example, the program is an instance of “Global News at 11”, although this program data for the time/day window and channel need not necessarily be known to the SPS 110, i.e. the request could simply comprise a start time, end time and channel number. The selection, typically from a menu or user interface option provided by the application, can be an explicit discrete selection of a single time/day/channel window or the selection can be to record a number of time/day/channel windows. For example, where program data is available, the request could comprise a program identifier including the series and episode or a program series and if time/day/channel information is not also provided, these can be determined by the SPS 110. In any case, these requests are accumulated by the SPS 110 in advance of the time/day window for program transmission, so that by the time a given program is broadcast, the total number of requests for recordal of the program is known to the SPS 110. Note that requests for recordal of a program may include a requested or default padding before and after the expected program start and end times. In any case, in this respect, the operation of the method is conventional.

Departing from the conventional approach, at some time before the time of broadcast, the SPS 110 makes a decision in relation to the number N of private copy replicas of the broadcast which will be written to the cloud storage system, CSS 112, step 202. This number N will in general be less, but will not be more, than the total number of requests for program recordal in accordance with the likelihood that users who have requested the recording will actually view the recording at a later time. In particular, the number N will be no more than the I/O capacity of the CSS 112, i.e. the total number of files that can be written to CSS 112 at a given time, but as will be seen from the explanation below, this still enables the system to perform better than the conventional approach.

In the illustrated example in FIG. 2, where 6 requests have been made, a decision is made to only store N=3 replicas of the broadcast in CSS112. Thus only 50% of the requests will result in a private copy of the program being recorded in CSS 112. Details of how the proportion of requests for recordal is determined are provided below.

At step 204, the SPS 110 requests the CSS 112 to store N=3 replicas of the program and in response, the CSS 112 replies by providing identifiers for N replicas of the program in storage, step 206. Identifiers for the replicas are typically provided in the form of a respective URL (uniform resource locators) for each replica.

Unlike in conventional approachs, the URLs are not at this stage allocated (or bound) to respective media devices. Instead, URLs are only allocated in response to an application running on a media device subsequently requesting the SPS 110 to play the recording of the program.

In the example, at step 208, an application running on media device 116C requests the SPS 110 to play the recording. At step 210, SPS 110 allocates a first URL previously received from the CSS 112 to the media device 116C and removes this from the pool of available private URLs. At step 212, the URL is provided to the media device 116C which can then stream the program content from the private location in CSS 112.

The process is repeated at steps 214-218, when media device 116E requests the SPS 110 to play the recording, and so on until all requests for playing the respective recordings are complete.

As will be seen, the embodiment employs a late-binding of URLS for program recordings in CSS 112 to media devices 116. The intent to need a recording, potentially along with the desired padding, is communicated to the SPS 110 and at the time of the specified target start and end time, copies are created by the CSS 112 using unique recording instance identifiers, to create a pool of individual recordings. When a subscriber chooses to play a recording, their media device 116 claims their previously scheduled recording replica. A mapping is created for this recording between the unique recording instance identifiers and the media device, which is treated as a permanent link. Once bound to the subscriber, as requested by the subscriber, the link is not used by any other subscriber.

Note that in some implementations, multiple different users can operate a given media device and in that case, a unique recording instance identifier can be allocated to a specific subscriber, rather than the device itself.

In any case, this approach of assigning recording resource locators at the first play-out time effectively spreads the load of allocating URLs to media devices 116. So instead of the conventional approach of allocating URLS to media devices 116 immediately a program is broadcast, this load is spread across the range of times of users requesting playback of recordals, starting from step 208 in the example of FIG. 2. It will also be seen that unnecessary processing to determine recording locators for replicas which would never be played is eliminated.

While the determining of the proportion of replicas to requests for recordal should be such that all subsequent requests for playback result in a URL being available for allocation to a media device, it is statistically possible that in some cases, all recording replicas will be claimed and any additional playout requests would fail to a “not found”-type error.

Note that such errors can occur in the conventional approach where the number of requests for recordal exceeds the I/O capacity of the CSS 112 and only a limited number less than the requested amount of replicas of a program are stored in CSS 112. In that case, however, users who would not subsequently request playback of a recordal can be allocated a URL with a corresponding replica, while users who would subsequently request playback of a recordal can be allocated a URL without a corresponding replica, i.e. a proportion of replicas are actually wasted on users who will not use them. As such, embodiments of the present invention can perform at least as well as in the conventional case in the case of overload as, in the present case, replicas are not allocated to a media device 116 until playback is requested.

In this regard, it will also be appreciated that certain users will use their media device application to delete a recording without requesting playback of a recording, perhaps because they are approaching a storage limit or are simply no longer interested in viewing the recording. In this case, a replica will not have been allocated to the media device 116 and so will be available for another user, thus reducing further the possibility of an error.

It should therefore be appreciated that the present invention allows the CSS 112 to operate at much higher levels of utilization than in the past, as the storage provided can be much closer to what is actually required by users of the system.

It will be seen that in order to implement the present invention, it is not necessary to integrate program guide data into the SPS 110 (or CSS 112). Requests for recordals from media devices 116 can simply be for a time/day slot for a given channel, and even if such requests do identify a program, the SPS 110 does not necessarily need to use this information.

Thus, it is sufficient for the SPS 110 to have some knowledge of statistical trends of recording requests and playout requests for a time/day window for a given channel in order to determine a proportion of replicas to maintain for any given broadcast program.

In some implementations, the SPS 110 monitors day-of-week and time-of-day values for the number of requests for a recording as well as the number of subsequent requests for playback of the recording. Over a series of weeks, these trends will identify for time/day windows on each channel, a proportion of replicas, with or without padding, to requests to capture as well as a confidence interval that the proportion will not lead to an error.

Note that the number of playback requests for a recording is an estimate of the likely total based on a measure of the number of playback requests made during a finite period of time, Tplayback, after the program broadcast. It is assumed that the temporal profile of playback requests is in general similar, with playback request rate peaking at a given time after broadcast and trailing off afterwards so that an estimate of total requests can be made from those made during the Tplayback window, especially if this is long enough to capture a peak in playback request rate.

In some implementations, a machine learning regression algorithm such as Support Vector Regression could be user to predict the percentage of recordings that will likely be viewed. Furthermore, a configurable padding can be added to a predicted percentage of recordings to guard against the condition where all replicas may be claimed.

Should the SPS 110 receive a recording request for an inordinately high or low number of replicas, when compared to the existing trends for a time/day window on a channel, this can serve as a signal that either the content is changing in popularity, that a new series is now occupying that time slot, or that a special event (sports, award show, etc.) is airing. This can signal to the SPS 110, to reset historical trend information for a program or channel time window, so that a new trend can be learned.

Nonetheless, knowledge of program information can enable more intelligent decision making in relation to the likelihood users will request playback of a recording as explained below. Having direct knowledge of the program or type of program being recorded allows the SPS 110 to leverage historical performance tied to program or program genre, i.e. a priori statistics on the expected percentage of playouts for the recording. For instance, news and series older than 3 years are likely to have a lower percentage of recordings played out by subscribers than new series, sporting events, or one-time recordings. These a priori statistics need not be limited to program or series, but may also take into account common events like season premiere and season finales as having increased demand adjustments.

In any case, these expected percentages can be provided to the SPS 110 when requesting the replicas be created in CSS 112 or this data can be exposed by a 3rd party information provider via an API (not shown) to the SPS 110 to be pulled as required.

Thus, an example implementation could include a scenario where recordings to be captured are classified into buckets based on knowledge of the type of program being broadcast These buckets can be assigned expected percentage of play-out, where new series or sporting events are assigned 100%, popular running series are assigned 90%, older series are assigned 40%, and recurring news programs are assigned 30%. This expected play-out percentage is leveraged when the program is broadcast and the replicas are to be created.

It will also be appreciated that knowledge of the historic playback request rate for a given time/day and channel as well as knowledge of the program information itself can be combined before making a final decision in relation to the proportion of replicas to be stored in CSS 112 for a given time/day and channel.

Separately, as well as knowledge of the historic playback request rate and the program information, the capacity of the CSS 112 itself can be used to determine the proportion of replicas to stored in CSS 112.

Thus, where the SPS 110 has high confidence in the CSS 112 being able to record higher numbers of replicas for a broadcast at a given time/day without causing I/O issues, possibly based on past demand and performance, then a higher proportion of replicas to be stored in CSS 112 can be determined and vice versa.

Alternatively, if the SPS 110 has some control over CSS 112, it is possible for the SPS 110 to request a defined I/O budget for recording the determined number of replicas of a broadcast program, while allocating the limited remainder of I/O capacity for other tasks which may not be latency sensitive.

Again, knowledge of program information can be used to determine how aggressively the proportion of replicas to be generated for a given program can be cut, in the event that a CSS I/O overload were going to be likely, e.g. where the total number of recordals requested across all channels for a given time/day were known to be in excess of CSS I/O capacity. In this case, the most aggressive resource shedding occurs on the programs least likely to be viewed, while still providing reasonable assurances for availability of play-out for programs most likely to be viewed. Note that in such cases, it is appreciated that it will be likely that insufficient replicas may be generated for some programs, but the number of recording errors generated using this approach is almost certainly going to be less than if using the conventional approach where the SPS 110 simply requested the required number of replicas for all record requests.

One approach to learning/predicting consumption can begin with conservative projections where little or no shedding is used and thus a relatively high proportion of replicas to record requests is used. As the system 110 learns from subscriber behavior, series, assets, and genres in general, the required proportion of replicas to record requests can slowly decline, but if there is an unexpected event, then the required number of copies can quickly increase. For example, a semi-popular program could reach an equilibrium proportion of replicas to record requests with no history of having come within 10% of exhausting the allocation of recording locators-a safe buffer. However, an unexpected event may arise that drives additional popularity that results in not having enough replicas available and in response, the system can rapidly increase the proportion of replicas to record requests for a subsequent episode of the program—an additive decrease and a multiplicative increase in proportion of replicas to requests in response to changing subscriber behaviour. Using the feedback loop, such a condition can dynamically increase the proportion of replicas to record requests for subsequent time/day windows of that channel or broadcast of the program.

### Modeling

To estimate an expected number of playout attempts, historical data can be modeled as a binomial distribution where the “success” of each event is denoted when a captured replica is played out to a subscriber. However, to aid with the calculations in this model, this can be measured in granularities of 10's, 100's, or 1000's of replicas, as appropriate, rather than individual replicas to ensure the n value does not grow too large.

As such, the model would have the following values:
p
=percent of replicas that are streamed to subscribers for the given time slot and channel
k=expected number of replicas (in 100's) played out for this time slot and channel
n=requested number of replicas (in 100's)

$$p ( k ; n , p ) = ( \begin{matrix}n \\ k\end{matrix} ) {{p}^{k} ( 1 - p )}^{( n - k )}$$

The model then uses the cumulative distribution function to find the number of replicas needed to meet a given probability threshold (e.g., 99.5% chance that all playout requests are successful).

$$P ( x ; n , p ) = {\sum }_{k = 0}^{χ} ( \begin{matrix}n \\ k\end{matrix} ) {{p}^{k} ( 1 - p )}^{( n - k )}$$

For example, assume that a given time slot on a channel has historically shown that 35% of the replicas are played out to subscribers, and the system receives a request for 1000 replicas of a recording during that time slot. The target is set to record enough replicas such that the replicas are not exhausted (i.e., play out of all replicas succeeds) with at least a 99.5% probability. The system finds x (in 100's of replicas) such that:

$$P ( x ; 10 , 0.5 ) = {\sum }_{k = 0}^{x} ( \begin{matrix}10 \\ k\end{matrix} ) {0.35}^{k} {( 0.65 )}^{( 10 - k )} \geq 0.995$$

Iterations through this function shows:
At x=4, P (4; 10,0.35)=0.7515
At x=5, P (5; 10,0.35)=0.9051
At x=6, P (6; 10,0.35)=0.9740
At x=7, P (7; 10, 0.35)=0.9952

Therefore, the system can signal that the CSS 112 should only create 700 (i.e., x=7) replicas of the requested recording to achieve the expected state of satisfying all play-out requests with at least a 99.5% confidence level. This results in an immediate 30% savings in CSS resource consumption with only an extremely rare chance that the subscriber is ever impacted.

Should the CSS 112 need to be more aggressive in shedding resources, it may throttle down the required statistical assurance threshold to 97%. In this case, the SPS 110 would instruct the CSS 112 to capture 600 replicas of the recording (x=6), which results in a 40% savings.

Further, the figures above show that this method can be moderately used even while not in an overload state to provide significant cost savings to a service provider. Using the example of 1000 requested recordings with a 35% probability of an instance being played by a subscriber, the binomial distribution model shows that if the method captures 800 of the requested 1000 replicas, the probability of all play-out attempts being successful is 99.99%. Capturing 900 replicas results in a near statistical impossibility of failing a play-out due to a lack of replicas.
At x=8, P (8; 10,0.35)=0.9999
At x=9, P (9; 10,0.35)=1.0000

Thus, the system can be active in a much less aggressive mode, assuming the CSS I/O will not be overloaded, and still result in significant cost savings and elimination of waste while almost assuredly not impacting subscribers.

As described above, in particular, where program data is not available to the SPS 110, the number of replicas requested for play-out for the given time/day window on a channel can be tracked to determine if a trend for the given time/day window for the channel has changed.

The requested number of replicas can be compared against this average and is accepted if it falls within a specified variance with the number of recording requests for the time/day window for the channel. However, if the requested number of replicas is too far outside a variance, for example, a popular sporting event or awards show, the proportion of replicas to requests can be chosen to be as high as possible, if not maximal. Should the requested number of replicas the following weeks of the time/day/channel window continue to fall outside of the variance, the modelled number, 35% in the example above, can be discarded and instead the proportion of replicas gradually decreased from the highest number towards what may then become a new equilibrium proportion for the time/day/channel. This scenario may be likely as a season for a series completes and a new series begins.

Also, while the binomial distribution above leverages a constant probability across subscribers for viewing an instance of a recording (and this assumption would be sufficient to model the population in aggregate), alternative implementations of the invention may employ a per-subscriber, per-series probability to to determine the proportion of replicas to requests for a time/day/channel or program.

For example, the entire subscriber population may show a 35% take-rate for viewing the recordings of a specific series, and this probability may generate an adequate number of replicas for each recording to ensure play-out demands are likely all met.

However, if the subscriber population includes a segment with relatively high take-rates for their recordings of this series (e.g., 50-70%) and a segment with relatively low take-rates (e.g., 5-10%), corresponding to the long tails of the model's distribution, then a hybrid of providing the high take-rate subscribers with a limited number of guaranteed replicas while other subscribers would be provided with access to the remaining number of replicas only when they requested playback as described above.

In this case, each subscriber in the high take-rate group can be assigned a replica at recording creation time, reserving their replica immediately upon creation as in the conventional approach. The remaining replicas are left in the unclaimed pool and are made available for any other subscriber on a first-come, first-served basis as described in relation to FIG. 2. Thus, the subscribers in the high take-rate group have a guarantee that a replica is available when they wish to watch a recording. Other subscribers still have all the statistical assurances noted above to also have a replica to view, but these will likely be casual viewers of this content with a lower level of investment should replica exhaustion occur.

It should be noted that the time/day window specified in a recordal request may include a partial broadcast program or multiple separate programs and in embodiments of the invention which employ program data, playback information for such multiple programs and/or program types can be taken into account when determining the proportion of replicas to recordal requests.

It will be appreciated that some requests for recording program content can be received while a program is being broadcast. In some embodiments of the present invention, rather than explicitly responding to such a requests by attempting to make a private recording of that program, in addition to those which were scheduled before broadcast time, the SPS 110 can wait until that user/media device subsequently requests to view the recording before allocating a URL from the URLS provided to the SPS 110 at step 206, as shown in FIG. 2. Clearly accommodating such late requests may require a fractional increase in the number record requests which are made at step 204, but it means that the benefits of the present invention can be applied to such late requests as well as to scheduled requests.

In the above described embodiments, requests for recording a program may be dropped in order to reduce the resources involved in generating, maintaining and providing private copies of recordings and in particular ensuring that a maximum number of simultaneous recordings being written to the CSS 112 is below the I/O capacity for the system.

So while dropping a request to record the entire program may be 17ecessary in some cases, lowering the peak I/O demand can also be achieved by dropping a requested or default-configured padding before or after the program. Since this is a time period where one program starts and another program ends, the padding values create overlap for recordings of the previous program and recordings of the subsequent program. The total number of requests for recording a previous program as well as the requests for recording a subsequent program, while each may be below the I/O capacity, when added together may exceed the I/O capacity.

In more detail, as will be understood, programs are scheduled for broadcast in time slots in accordance with program guide data (PGD), for example, most programs are aligned to start and end on the hour or half hour. It is normal when recording such programs to add a relatively small fixed padding before and/or after the scheduled start and end times to ensure the program of interest is not cut off due to an early start or late end of airing relative to the PGD.

Thus, instead of a recording activity taking place between 12:00 to 1:00, the request for recordal with padding may be 11:59 to 1:05, one minute early, and 5 minutes late. However, the padding, which is required for the best user experience, may have the effect of increasing the amount of I/O activity for a short period of time where requests for recording previous or following programs on the same channel have also been made. Thus, during the period of the padding, the total recording concurrency, and thus I/O and compute, can increase by comparison to recording without padding. The following example illustrates this assuming the same storage system is responsible for all the recordings:

NO PADDING

| | |
|---|---|
| Channel 1 - Program A (12:00 to 1:00) | Program B (1:00 to 1:30) |
| Channel 2 - Program X (12:00 to 1:00) | Program Y (1:00 to 2:00) |

User1 has requested program A, B.
User2 has requested program B, X, Y
User3 has requested program B

Total Recording Demand at 12:59 is 2: User1(A) and User2(X). Since the start and end are the same time for AB and XY at 1:00 PM, one ends and the other begins so there is no overlap of need.

WITH PADDING

| | |
|---|---|
| Channel 1 - Program A (12:00 to 1:00) | Program B (1:00 to 1:30) |
| Channel 2 - Program X (12:00 to 1:00) | Program Y (1:00 to 2:00) |

User1 has requested program A, B but has asked for 5 minutes of pre and post padding.
User2 has requested program B, X, Y but has asked for 5 minutes of pre and post padding.
User3 has requested program B but has asked for 5 minutes of pre and post padding.

The effect is that the program recordings are now longer than the PGD.

| | |
|---|---|
| Channel 1 - Program A (11:55 to 1:05) | Program B (12:55 to 1:35) |
| Channel 2 - Program X (11:55 to 1:05) | Program Y (12:55 to 2:05) |

Total Recording Demand at 12:59 could be 7: User1(A, B), User2(B, X, Y), and User3(B).

If this additional peak concurrency exceeds the I/O capacity of the CSS 112, then some requests for recording may be lost, lose pre padding, start of the program, end of the program, or just the end program padding.

Thus, in some implementations of the present invention in addition or as an alternative to steps 202, 204 of the implementation described in relation to FIG. 2, the SPS 110 takes into account whether requests for simultaneously recording padded portions of programs have been made.

These can comprise requests to record successive programs on the same or different channels where the end padding of one program overlaps with the start padding of another program; or when the start or end padding of programs broadcast on different channels overlaps.

If so, and if the total number of requests for recording both programs during the overlapping periods of padding would cause the I/O capacity of the CSS 112 to be exceeded, then the padding of recordals of one or other programs can be removed, before the request(s) to record the program content are provided to the CSS 112.

Again, in addition or as an alternative to steps 202, 204 of the implementation described in relation to FIG. 2 and the above described variant, the SPS 110 can be configured to identify whether requests for recording successive programs are from the same user or media device.

In this case, the SPS 110 can treat such requests as a single request to record a superset of the two (or more) programs including a pre-padding of the first program and post padding of the last program. Again, once the combined single request has been determined, the request can be provided to the CSS 112. This avoids the increase in I/O caused by attempting to record the programs with padding separately and so can reduce peak I/O demand without the need to drop any padding.

Note that implementations which adjust the padding of recording requests as described above can be implemented either with the late binding of URLS as described in relation to FIG. 2; or with conventional allocation or URLs to recording requests.

While the above embodiment has been described as being performed by SPS 110 controlling copies of content stored in CSS 112, it will be appreciated that the invention could analogously by implemented by an operator headend 104 storing content in media content management device(s) 108.

1. A method for recording broadcast content comprising:
receiving from a plurality of media devices respective requests to record program content broadcast in a given time window on a given channel;
determining a number of requests for recording the program content based at least on a total number of said requests and a likelihood that playback of a recordal will be requested by a media device;
requesting a storage system to make said determined number of requests for recording;
receiving from the storage system a plurality of identifiers corresponding to said determined number, each identifier identifying a location in said storage system of a respective recording of said program content;
responsive to receiving a request from a media device for playback of said program content, allocating an identifier from said plurality of identifiers to said media device and removing said identifier from said plurality of identifiers available for subsequent playback requests; and
providing said identifier to said media device so that said media device can retrieve said recording from said storage system for playback of said program content.

2. The method of claim 1 wherein said determining is based on a historical number of requests for playback of recordals made for a given time window on a given day for a given channel.

3. The method of claim 1 wherein said determining is based on a capacity for said storage system to make a maximum number of recordings of broadcast program content.

4. The method of claim 1 wherein said determining comprises:
receiving an identification of a program or program type of said program content broadcast in said given time window on said given channel; and
receiving an indication of a proportion of recordal requests to playback requests for said program or program type;
wherein said determining is further based on said indication.

5. The method of claim 1 wherein said determining is responsive to receiving a variation in the total number of requests for recording the program content relative to historical total numbers of requests for recording the program content for varying a determined proportion requests for recording relative to said total number of requests for recording.

6. The method of claim 4 wherein said determining is responsive to receiving a variation in the total number of requests for playback of the program relative to historical total numbers of requests for playback for varying a determined proportion requests for recording relative to said total number of requests for recording subsequent broadcasts of either: program content in said time window for said channel; said program; or programs of said type.

7. The method of claim 1 further comprising:
receiving an indication of a probability of each media device requesting playback of recorded program content; and
responsive to a number of media devices less than said number of requests for recording having an indication higher than a threshold probability, allocating to each said media device of said number of media device a respective one of said identifiers before receiving a request for playback of said program content from said media devices.

8. The method of claim 1 comprising receiving more than one request from respective users of a media device, each request comprising a separate request for recording the program content.

9. The method of claim 1 wherein said determining is responsive to the total number of said requests being less than an I/O capacity of said storage system at any given time for requesting the storage system to record the total number of requests.

10. The method of claim 1, wherein said identifiers comprise respective Uniform Resource Locators (URLs).

11. The method of claim 1 further comprising:
prior to requesting said storage system to make said determined number of requests and responsive to the determined number of requests exceeding an I/O capacity of said storage system at said given time:
identifying one of more of said requests in which the request to record broadcast program content comprises padding of broadcast program content occurring at said given time; and
adjusting one or both of a starting recording time or an ending recording time of at least some of said identified one or more requests in order to reduce said padding and to reduce the total number of requests for simultaneously recording the program content at said given time to below said I/O capacity of said network storage system

[symbol]

12. The method of claim 1 further comprising:
prior to requesting said storage system to make said determined number of requests and responsive to the determined number of requests exceeding an I/O capacity of said network storage system at said given time:
identifying a plurality of requests from a given media device to record successive programs broadcast on a given channel and comprising padding of broadcast program content occurring at said given time; and
combining said plurality of requests into a single request having a starting recording time corresponding to a starting recording time of the earliest of said identified plurality of requests and an ending recording time corresponding to an ending recording time of the latest of said identified plurality of requests to reduce the total number of requests for simultaneously recording the program content at said given time to below said I/O capacity of said network storage system;

13. A service provider system comprising a computer system connected across a network to a plurality of media devices and a storage system, the service provider system being configured to perform the method of claim 1.

14. A system comprising the service provider system according to claim 13 and a cloud storage system.

15. A computer program product comprising a non-transitory computer readable medium having stored thereon computer executable instructions which when executed on a processor of service provider system connected across a network to a plurality of media devices and a storage system are configured to perform the method of claim 1.

16. A method for recording broadcast content comprising:
receiving from a plurality of media devices respective requests to record broadcast program content in a network storage system, each request indicating a starting recording time, an ending recording time and a channel on which said program content is to be broadcast;
determining a total number of requests for simultaneously recording program content at a given time;
responsive to the total number of requests exceeding an I/O capacity of said network storage system at said given time:
identifying one of more of said requests in which the request to record broadcast program content comprises padding of broadcast program content occurring at said given time; and
adjusting one or both of a starting recording time or an ending recording time of at least some of said identified one or more requests in order to reduce said padding and to reduce the total number of requests for simultaneously recording the program content at said given time to below said I/O capacity of said network storage system;
requesting the storage system to make said requests for recording; and
receiving from the storage system a plurality of identifiers, each identifier identifying a location in said storage system of a respective recording of said program content; and
providing respective identifiers to said media devices, so that said media devices can retrieve said recordings from said storage system for playback of said program content.

17. A service provider system comprising a computer system connected across a network to a plurality of media devices and a storage system, the service provider system being configured to perform the method of claim 16.

18. A computer program product comprising a non-transitory computer readable medium having stored thereon computer executable instructions which when executed on a processor of service provider system connected across a network to a plurality of media devices and a storage system are configured to perform the method of claim 16.

19. A method for recording broadcast content comprising:
receiving from a plurality of media devices respective requests to record broadcast program content in a network storage system, each request indicating a starting recording time, an ending recording time and a channel on which said program content is to be broadcast;
determining a total number of requests for simultaneously recording program content at a given time;
responsive to the total number of requests exceeding an I/O capacity of said network storage system at said given time:
identifying a plurality of requests from a given media device to record successive programs broadcast on a given channel and comprising padding of broadcast program content occurring at said given time; and
combining said plurality of requests into a single request having a starting recording time corresponding to a starting recording time of the earliest of said identified plurality of requests and an ending recording time corresponding to an ending recording time of the latest of said identified plurality of requests to reduce the total number of requests for simultaneously recording the program content at said given time to below said I/O capacity of said network storage system;
requesting the storage system to make said requests for recording; and
receiving from the storage system a plurality of identifiers, each identifier identifying a location in said storage system of a respective recording of said program content; and
providing respective identifiers to said media devices, so that said media devices can retrieve said recordings from said storage system for playback of said program content.

20. A service provider system comprising a computer system connected across a network to a plurality of media devices and a storage system, the service provider system being configured to perform the method of claim 19.

21. A computer program product comprising a non-transitory computer readable medium having stored thereon computer executable instructions which when executed on a processor of service provider system connected across a network to a plurality of media devices and a storage system are configured to perform the method of claim 19.
